(19) United States
(12) Patent Application Publication
(10) Pub. No.: US 2016/0210685 A1
(43) Pub. Date: Jul. 21, 2016

(54) INTERACTIVE COMPONENT ORDERING AND SERVICING SYSTEM AND METHOD

(71) Applicant: APPAREO SYSTEMS, LLC, Fargo, ND (US)

(72) Inventors: David C. Batcheller, Fargo, ND (US); Jacob A. Halvorson, Moorhead, MN (US); Daniel D. Schulz, Fargo, ND (US); Jason Powell, Fargo, ND (US); Travis N. Bader, Phoenix, AZ (US); Pradhuman Rana, West Fargo, ND (US); Tanya G. Bitzan, Moorhead, MN (US)

(73) Assignee: Appareo Systems, LLC, Fargo, ND (US)

(21) Appl. No.: 14/915,600

(22) PCT Filed: Aug. 28, 2014
(86) PCT No.: PCT/US14/53285

§ 371 Date: Feb. 29, 2016

Related U.S. Application Data
(60) Provisional application No. 61/870,925, filed on Aug. 28, 2013.

(51) Int. Cl. G06Q 30/06; G06Q 20/32; G06Q 10/00

(52) U.S. Cl. CPC G06Q 30/0635; G06Q 30/0643; G06Q 10/20; G06Q 20/322

(57) ABSTRACT

A platform for a service tool comprising a mobile device, an application executing on the mobile device for displaying three-dimensional CAD-style drawings of a system and all of its important components, and a cloud-based service that allows an operator or service personnel to order components and to exchange information (including video, audio, and other data types) with a remotely-located service provider. The system allows users to view detailed three-dimensional images of parts or part assemblies, choose distributors of those parts, and order to those parts to be shipped.

### CROSS-REFERENCE TO RELATED APPLICATIONS

This application claims priority International Application No. PCT/U.S. 2014/053285, filed Aug. 28, 2014, which claims priority in U.S. Provisional Patent Application No. 61/870,925, filed Aug. 28, 2013, both of which are incorporated herein by reference.

### BACKGROUND OF THE INVENTION

1. Field of the Invention

The present invention relates generally to the field of product support and service, and specifically to a method of allowing an operator or service personnel in a remote location, such as a field, to view and access information about service parts and to order them from the remote location.

2. Description of the Related Art

Every time a piece of equipment, such as a tractor or a field-working implement, breaks down in the field, it can cost the farmer or operator valuable time to find the failed component, identify it, locate and visit or contact a dealership, order the part, wait for it to be shipped, pick it up, and have it installed. For example, down time for a tractor or implement can cost a farmer thousands of dollars or more, especially if a crop is at a critical stage and the down time prevents some necessary operation from being performed in a timely manner. For example, the sugar content in a sugar beet plant can change in a very short time, and harvesting a crop of sugar beets too late may mean that the chemical makeup of the crop has changed, reducing the sugar content and dramatically affecting the value of the crop.

The same can be said for construction equipment being used to complete a large project. Down time can cause a tightly scheduled project to slip, and the contractor can be penalized financially for a schedule slip. Both construction and farming are also weather-dependent, and there are only so many days in a season when work can be done. Down time can affect many other industries, as well. When a piece of machinery is down, money is often lost. Manufacturing lines, printing operations, commercial shipping, and many other industries are affected by the down time of machinery.

Today when a machine fails, the operator or service person must try to find the part that failed, go to the shop and thumb through a user manual or find an electronic copy of the same manual online, try to locate the failed component on a black-and-white, two-dimensional line drawing from the manual, order the part, wait for it to be shipped, pick it up from the dealer, and install the part. The entire process is subject to human error, such as misidentifying the component, writing the part number down wrong, having the dealership order the wrong part, etc.

What is needed in the art is a portable service tool that can be used in the field at the point of failure, which can display a three-dimensional rendering of the entire system which can be manipulated in virtual space, allow the user to view individual subsystems and components of the system, also in three dimensions, and to order the part directly from the mobile service tool, without leaving the site or having to contact a service provider.

### SUMMARY OF THE INVENTION

According to one aspect of the present invention, a method for presenting and ordering service parts, comprising the steps of creating a three-dimensional model of a system, the system model comprising a plurality of three-dimensional models of components integral to the system, creating a database of service information, the service information comprising data related to one or more service providers capable of supplying parts corresponding to the three-dimensional models of components, uploading the three-dimensional model and database of service information to a centralized server, providing a mobile device capable of communicating with the centralized server, transferring the three-dimensional model and subsets of information from the database of service information to the mobile device, displaying the three-dimensional model and the component models as selected by a user on the mobile device, allowing the user to select one or more of the service providers, and allowing the user to order a part directly from the mobile device by interacting with the three-dimensional model and service information.

According to another aspect of the invention, a system for presenting and ordering service parts, comprising an information management function, a service management function, a centralized server, a mobile device, and an application running on the mobile device, wherein a user can display a three-dimensional model of a complex system on the application, select one or more subcomponents from the three-dimensional model, select one or more service providers capable of providing the subcomponents, and ordering the subcomponents from the service provider directly from the application.

These and other aspects of the invention will become obvious in the following discussion and corresponding figures.

### BRIEF DESCRIPTION OF THE DRAWINGS

FIG. 1 is a block diagram showing a high-level, functional view of the components of the service tool of the present invention.

FIG. 1A shows a flowchart of a workflow of one of the IMT component of FIG. 1.

FIG. 1B is an illustration showing a screen that might be seen in the “Create Model” step of FIG. 1A.

FIG. 1C shows a flowchart of a workflow of one of the SMT component of FIG. 1.

FIG. 2 is an example user interface display showing one embodiment of a “home” screen for the service tool of the present invention.

FIG. 3 is an example user interface display showing one embodiment of a “implement” screen for the service tool of the present invention.

FIG. 4 is an example user interface display showing one embodiment of a “subassembly” screen for the service tool of the present invention.

FIG. 5 is an example user interface display showing one embodiment of a “part selection” screen for the service tool of the present invention.

FIG. 6 is an example user interface display showing one embodiment of a “select service provider” screen for the service tool of the present invention.

FIG. 7 is an example user interface display showing one embodiment of a “shopping cart” screen for the service tool of the present invention.

### DETAILED DESCRIPTION OF THE PREFERRED EMBODIMENTS

### I. Introduction and Environment

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Additional examples include computing devices such as a mobile smart device including a display device for viewing a typical web browser or user interface will be commonly referred to throughout the following description. The type of device, computer, display, or user interface may vary when practicing an embodiment of the present invention. A computing device could be represented by a desktop personal computer, a laptop computer, “smart” mobile phones, PDAs, tablets, or other handheld computing devices. Healthcare providers may include any person or entity within the healthcare field, from insurance providers, to pharmacists, to hospitals, to doctors, and more. Said terminology will include the words specifically mentioned, derivatives thereof and words of similar meaning.

### II. Part Viewing and Ordering System 2

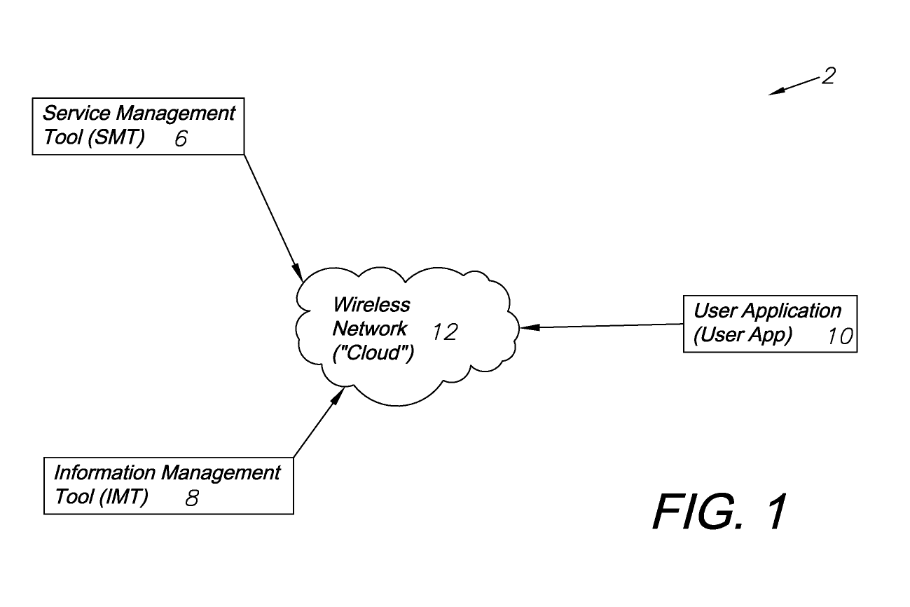

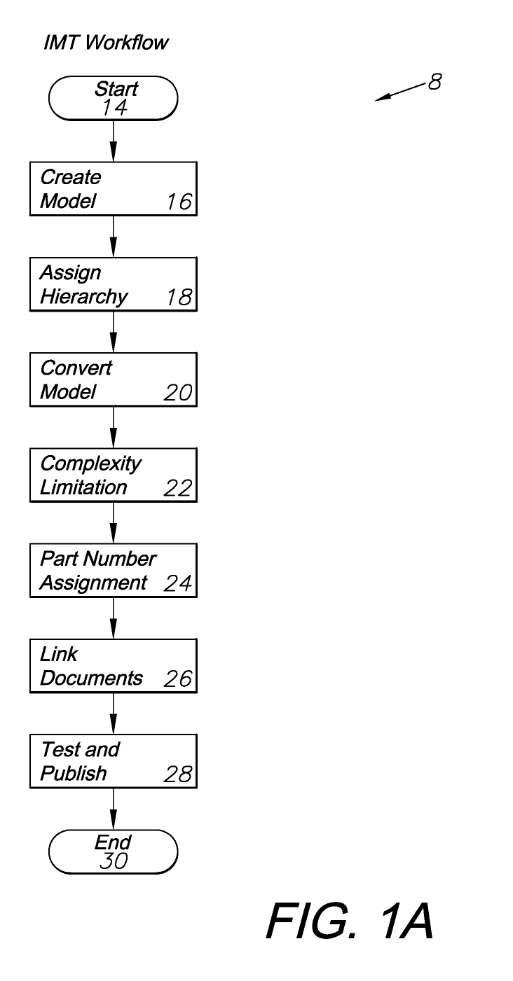

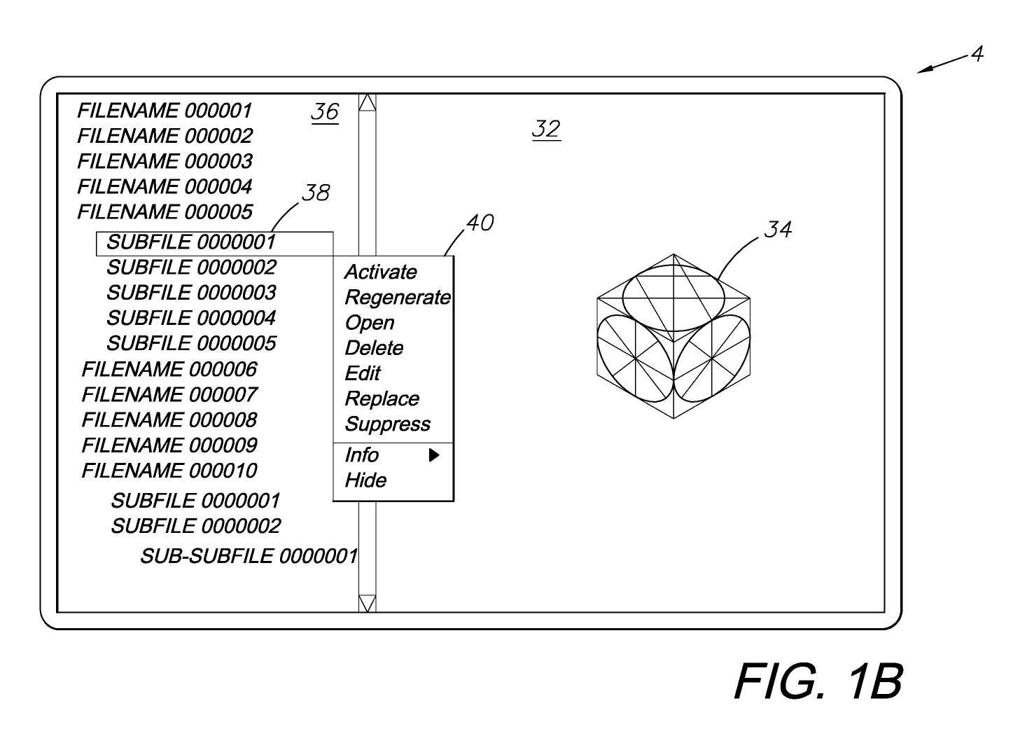

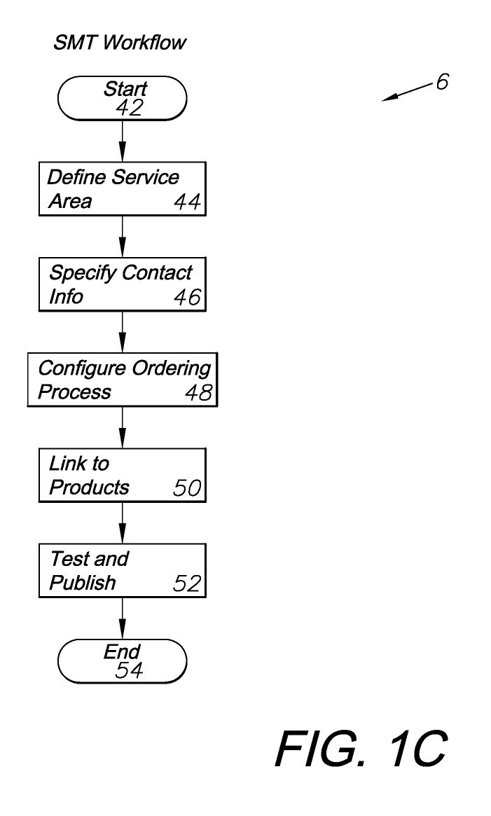

Referring to the drawings in more detail, FIG. 1 presents a block diagram showing a high-level, functional view of one embodiment of a service tool platform system 2. The service tool platform consists of four primary components, as shown on FIG. 1 and detailed in the following paragraphs. The four components are:
IMT—Information Management Tool 8: Provides the original equipment manufacturer the ability to import and link equipment images and documentation for use within the service tool as well as include specific branding (e.g. product/promotional branding).
SMT—Service Management Tool 6: Provides the ability to specify service contact information for products, general company information, location information and dealer-specific branding.
Wireless Network/“Cloud” 12: Provides storage and access to all service tool data as well as web-based administrative tools and reports. Data access is secure and limited to service tool components and tools.
User Application (the End User Experience) 10: The End User Experience is embodied in an iPad application, or an application hosted on a similar mobile platform or personal smart computing device 4. The application provides the end user with access to 3-D product imagery, product/service information, and access to service providers (real time or by delayed messaging).

These four components work together to create a “service tool platform,” or simply a “service tool.” The IMT 8 is a component that is used to create images and three-dimensional models of equipment, such as tractors, implements, and other vehicles, and import them up into the “cloud” for storage and later retrieval. Turning now to FIG. 1A, this figure shows one embodiment of the workflow of the IMT component. The process starts at 14.

The first step 16 in the IMT 8 workflow is to use the IMT to create a three-dimensional model of the system, where the system may include the major components of a tractor, implement, or any other appropriate complex system. These models are created and imported from a standard CAD program, such as AutoCAD, Pro-Engineer, or any other appropriate computer-aided drafting tool. At the “Create Model” step, relationships between parts (system to subsystem, subsystem to component, etc.) may be created. For example, at the top level, a “system” may be a model of an implement, such as a planter. This “system” model may be comprised of smaller “subsystems”, such as a “brake module”, “transmission”, or “blower motor”, and, in turn, each subsystem may be further broken down into “components”. For example, a “transmission” subsystem may have “components” such as a “gasket”, a “bushing”, or a “cluster gear”.

The next step 18 in the IMT Workflow of FIG. 1A is “Assign Hierarchy”. In this step, subsystems and components are assigned to different “layers”, where a layer is a grouping of parts the display of which can be turned on and off simultaneously. The use of hierarchy layers defines how the user of the service tool will be able to “drill down” (that is, to drop down or rise up in the level of abstraction shown) into a system and its subsystems.

The next two steps in the IMT Workflow of FIG. 1A are the “Convert Model” step 20 and “Complexity Limitation” step 22. In the “Convert Model” step, the three-dimensional models are converted (if necessary) into a graphics format which supports “decimation”. Decimation is a process whereby entities (such as polygons) are removed from a graphical model in order to limit the overall size of the model (for example, in order for the model to be rotated and moved on a computer or mobile device with limited processing and/or graphics ability). Once the model is converted to a format which supports decimation, the model may then be reduced in complexity (the Complexity Limitation step) whereby some of the data points defining the vertices of the model are removed, keeping the overall shape of the model but reducing the detail so that the model can be displayed on lower-end devices without performance issues.

Next in the IMT Workflow are the steps of “Part Number Assignment” step 24 and “Link Documents” step 26, whereby associations can be made between a component or subsystem on a model with underlying documentation, such as unit pricing, a page from an owner's manual, or a specification.

Finally, the models move to the “Test and Publish” step 28, where the models can be verified in a “staging” location, and then transferred to the cloud for storage and dissemination to other system components. The process ends at 30.

FIG. 1B is an illustration showing a user interface 32 screen that might be seen in the “Create Model” step of FIG. 1A. The figure shows a typical CAD model 34 of a component that can be associated with a subsystem or system, and moved through the other steps of the IMT Workflow. The model 34 may be a wireframe or solid visual representation of a part or piece of equipment. The user interface 32 is contained within the personal computing device 4. A list of parts or files 36 allows a user to select a selected file 38 which may be viewed, or which may contain sub-files which may be viewed. A selected file 38 may be otherwise interacted with using a sub-menu 40 containing various commands.

FIG. 1C is a flow diagram showing the workflow of the SMT component 6 of the part ordering and viewing system 2. The Service Management Tool 6, or SMT, provides the ability for a service provider (such as a dealership) to specify service contact information for an original equipment manufacturer's products, general company information, location information, and dealer-specific branding. The process starts at 42.

In the “Define Service Area” step 44 of FIG. 1C, one or more service areas are defined based upon a radius extending out from a particular dealer or service provider. This definition of a service area may also be defined using “geo-fencing”, which is the process of outlining an area of virtually any two-dimensional shape on a map by specifying endpoints or drawing line segments around the area.

In the “Specify Contact Information” step 46 of FIG. 1C, contact information such as contact type, name, availability, phone, email, etc. is defined for the service area defined in the previous step.

In the “Configure Ordering Process” step 48, the process used to order a component using the service tool can be defined, and template forms used in the process can be provided and incorporated into the tool. This ordering process is typically customized to the service provider.

In the “Link to Products” step 50 of FIG. 1C, the service provider can define which products or services they are able to provide from their specific location. Finally, the service information provided by the SMT can be tested and published at the “test and publish” step 52 to the cloud for storage and dissemination to other components of the service tool platform. The SMT process ends at 54.

In looking at the overall process and work flow of the system detailed in FIGS. 1-1C, the process can be summarized as follows: the original equipment manufacturer (such as an agricultural implement manufacturer, for example) can use the Information Management Tool, or IMT, to create detailed three-dimensional models of their products, and to define the hierarchy of the system components, as well as to link these models with the appropriate documentation and pricing information. These models are then uploaded to the cloud for storage and later dissemination to other platform components. Separately, the service provider can use the Service Management Tool, or SMT, to define information about their services and capabilities, including contact information, part availability, service area, and other appropriate information. This information can then be uploaded to the cloud for use with the IMT created data by the system.

Finally, a service tool application (or “app”), executing on a mobile device, such as an iPad, smart phone, mobile or tablet computer, or a laptop, can access the IMT and SMT information stored in the cloud to provide a rich end user experience. A user operating a vehicle in a field or at a construction site, for example, experiencing a problem with their vehicle can leave the vehicle bringing the mobile device executing the app with them. It should be noted that the mobile device used for this application may also be used for other purposes, including a vehicle display, virtual terminal, or other display function, within the vehicle. For example, in one embodiment, an operator may use an iPad or similar mobile device to control and display information regarding an implement the vehicle is towing. If the vehicle or towed implement suffers a service issue, the operator can stop the vehicle, grab the mobile device, put the device into “service tool” mode, and walk back to the problem area on the vehicle or implement. Then, using the mobile device in service tool mode (with the service tool application executing), the user can access a three-dimensional model of the vehicle or implement (downloaded from the cloud and originally created by the IMT), rotate and spin the model on the screen, dive down into the subsystem layers of the model, or into the component layers, until they have identified the part that is in need of service. The operator can then access service information about the part (by calling up the service provider information downloaded from the cloud and originally created by the SMT), and can check pricing and availability and even order the part, all without leaving the field.

The service tool app could also allow other functions, including but not limited to the following:
Taking a picture of the part (and any damage it may have) and sending the picture directly to the service provider.
Initiating a video conference with the service provider to ask questions that may not be covered in the online documentation.
Search the dealership network for the closest source of the part needed, or to inquire into the shipping schedule for a part should it need to be ordered.

The service tool of the present invention can also be used to collect information from a fleet of deployed vehicles and/or implements, information which can be collected and analyzed and used to predict when service parts might be needed. For example, if a fleet of similar implements are monitored within a certain service area corresponding to a dealership, and if the analyzed data from the fleet show that a certain part (such as a bushing on a transmission shaft) tends to fail after 500 hours of implement operation, the service tool platform can monitor the fleet within its area and predict when each implement will approach 500 hours of operation, and recommend to the dealer than a corresponding number of replacement parts be stocked and on hand before the failure occurs. The service tool app can then send a recommendation to the implement operator that the part (the bushing in this example) may be approaching its end of life, and that it might be wise to replace it as soon as convenient. Ideally, the notification and recommendation for part replacement comes well before an actual failure, allowing the operator of the implement to schedule service for the part at a time that is convenient for the operator, as opposed to waiting for the part to fail, which may happen at an unpredictable time, when the implement is most needed, such as during a harvesting operation.

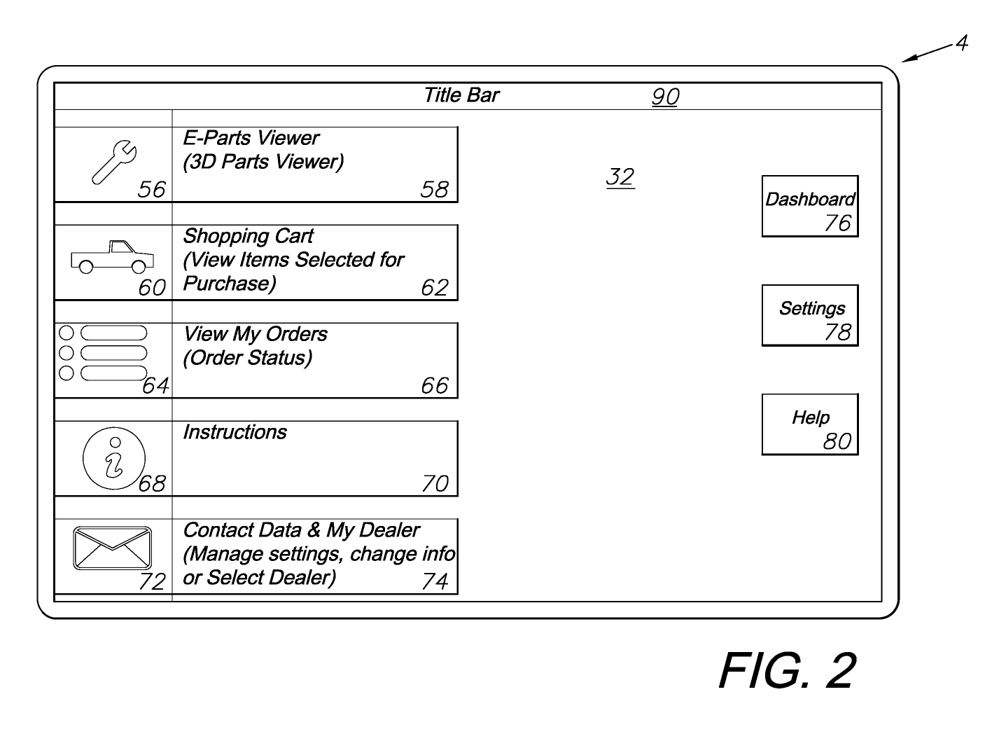

The remaining figures (FIGS. 2 through 7) provide example screenshots that might be used in an embodiment of the service tool application running on the mobile device. These figures are meant to provide examples only and are not meant to be limiting in any way. It would be obvious to one skilled in the art that changes to the overall content, look and feel, and menu design of the application can be changed without deviating from the inventive concept as described herein.

FIG. 2 is an example screen shot of a user interface 32 contained within a personal computing device 4 showing one embodiment of a “home” screen for the service tool of the present invention. This home screen might be used as a “landing page”, or the first page that is displayed when the application 10 is brought up. In provides menu selections in the form of links and icons on a touch sensitive screen (in one embodiment), allowing access to all functions of the service tool.

Some of the icons and interactive links to other features of the preferred embodiment of the present invention include a Parts Viewer icon 56 and associated description 58 of that feature; a shopping cart icon 60 and associated description 62 of that feature; an order status icon 64 and associated description of that feature 66; an instructions icon 68 and associated description of that feature 70; and a contact/settings icon 72 and associated description of that feature 74. Other preferred interactive buttons or links include a dashboard button 76 which takes the user to a home dashboard of the user device, a settings button 78 which allows the user to adjust certain settings associated with the user application 10 and/or the device 4, and a help button 80 which provides information to assist the user in interacting with the application 10 or device 4. A title bar 90 describes the user application 10 or the page on which the application is presently on.

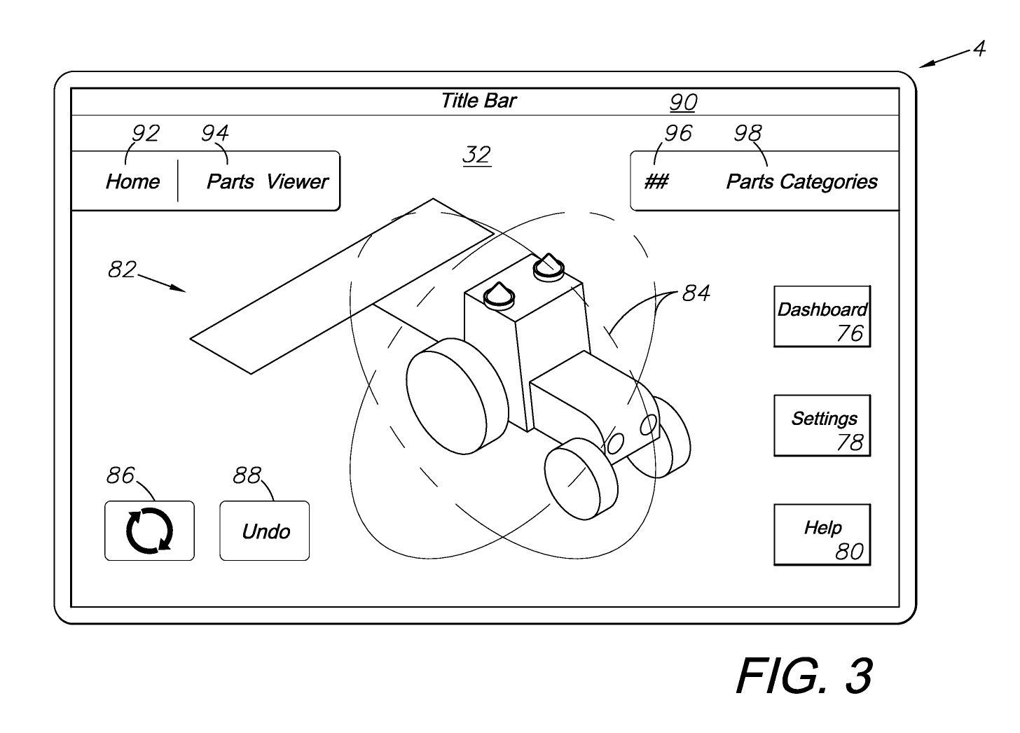

FIG. 3 is an example screen shot of a user interface 32 contained within a personal computing device 4 showing one embodiment of a “implement” screen for the service tool of the present invention. On this screen, the top-level “system” (an implement, in this example) is displayed. This three-dimensional and colored model is shown in proper scale to its real world counterpart, and the model can be rotated, spun, and flipped in virtual space so that all sides of the implement can be viewed by the user.

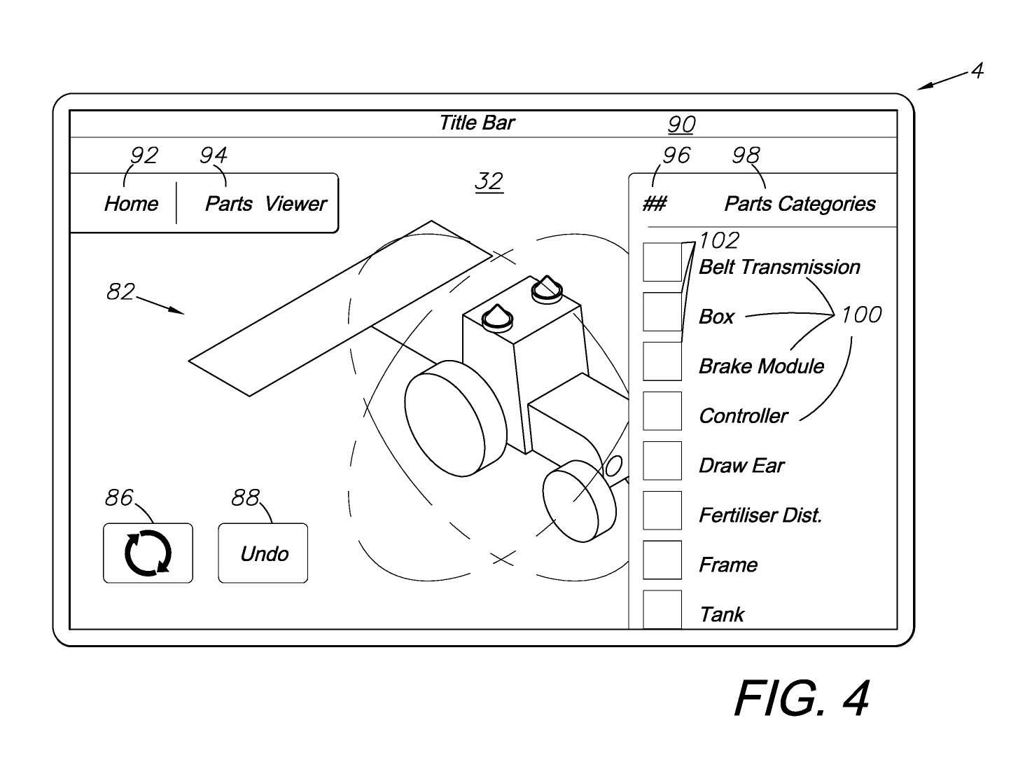

Features of a preferred view of such a display include a rotatable three-dimensional representation of a piece of equipment 82, such as a vehicle. A link to the home page 92, which is shown in FIG. 2, is included in this display. A title of the part or equipment 94 may also be shown. The equipment may have a part or equipment number 96. A link to a parts categories list 98 is also available. FIG. 4 expands upon this feature. A free rotation button 86 would allow the user to rotate the displayed equipment in the user interface 32. Any changes or rotation may be undone using the “Undo” button 88. The FIG. 82 of the equipment may be rotated along universal-coordinate system (UCS) designated by the ellipses 84.

FIG. 4 is an example screen shot of a user interface 32 contained within a personal computing device 4 showing one embodiment of a “subassembly” screen for the service tool of the present invention. In the previous figure (FIG. 3), a button labeled “Part Categories” appeared near the top of the display. By touching that button, the screen shown in FIG. 4 is displayed. A listing of available part categories (such as “brake module” or “fertilizer distribution”) is displayed, and the user can pick one of these categories in order to bring that subassembly or component into focus.

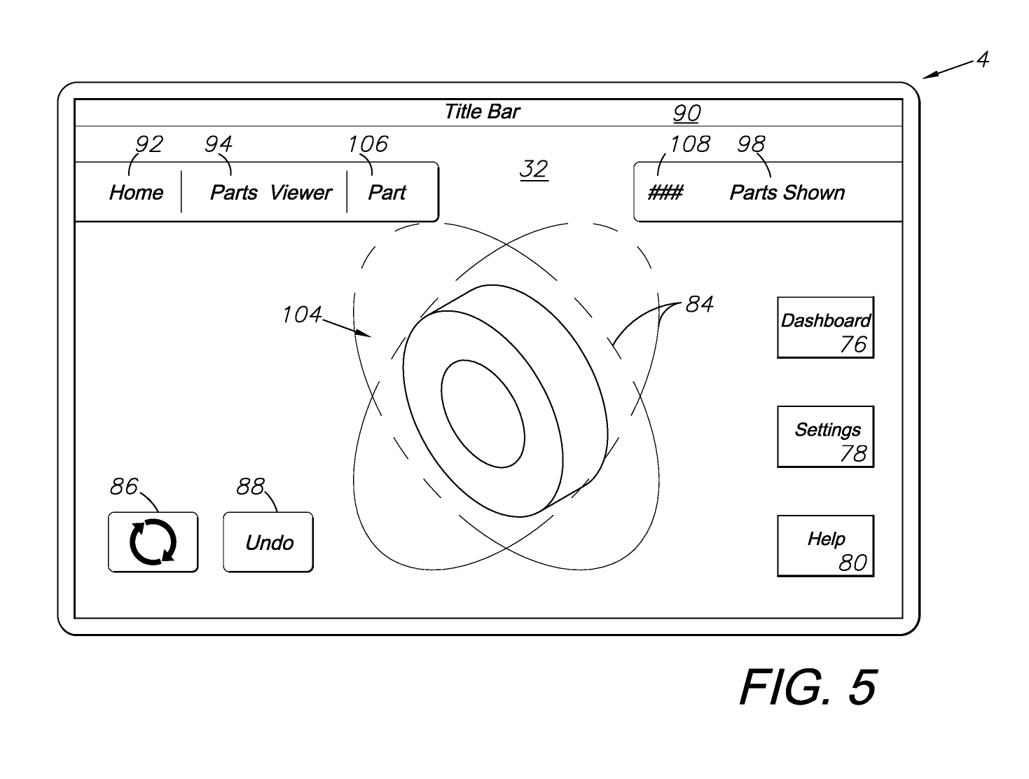

Features of a preferred view of such a display include a list of part names 100 and check boxes 102 associated with each part. The user may select one or more check boxes 102 and the associated parts will then be displayed in the user interface 32, as shown in FIG. 5.

For example, FIG. 5 shows an example screen shot where a tire subassembly has been selected from a selection menu similar to that shown in FIG. 4. The part displayed 104, here a tire, may be multiple parts and may be rotated similar to the equipment as discussed above. The name of the part 106 is displayed, as is the part number 108. The selected part is shown separate from the rest of the implement or system, so that the user can find the specific part in question. A subassembly like the tire shown in FIG. 5 may be broken down into further levels of abstraction, including other subassemblies and individual components. Once the part in need of replacement or service is selected, the user can then pull up a service provider screen in order to schedule service, order a part, or simply to get contact information for the provider.

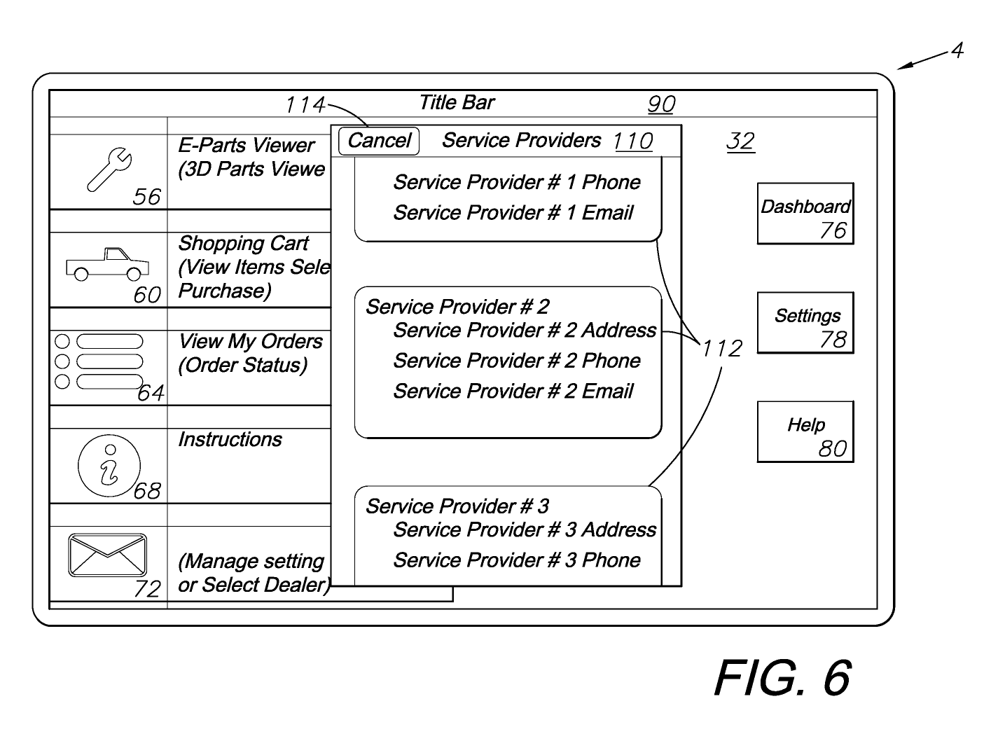

FIG. 6 is an example screen shot of a user interface 32 contained within a personal computing device 4 showing one embodiment of a “select service provider” sub-display screen 110 for the service tool of the present invention. This screen might be used once a specific part is identified for service or replacement. This screen can be used to display all service providers 112 within a certain radius, or perhaps throughout a national or worldwide network, such that the user can select a user and order a part or check availability and pricing, among other service related options. If the option is selected, the window may be closed by activating the cancel button 114. The user may select a service provider from the list of providers by using the touchscreen interface associated with the personal computing device 4, or other such interface (e.g. mouse and keyboard input).

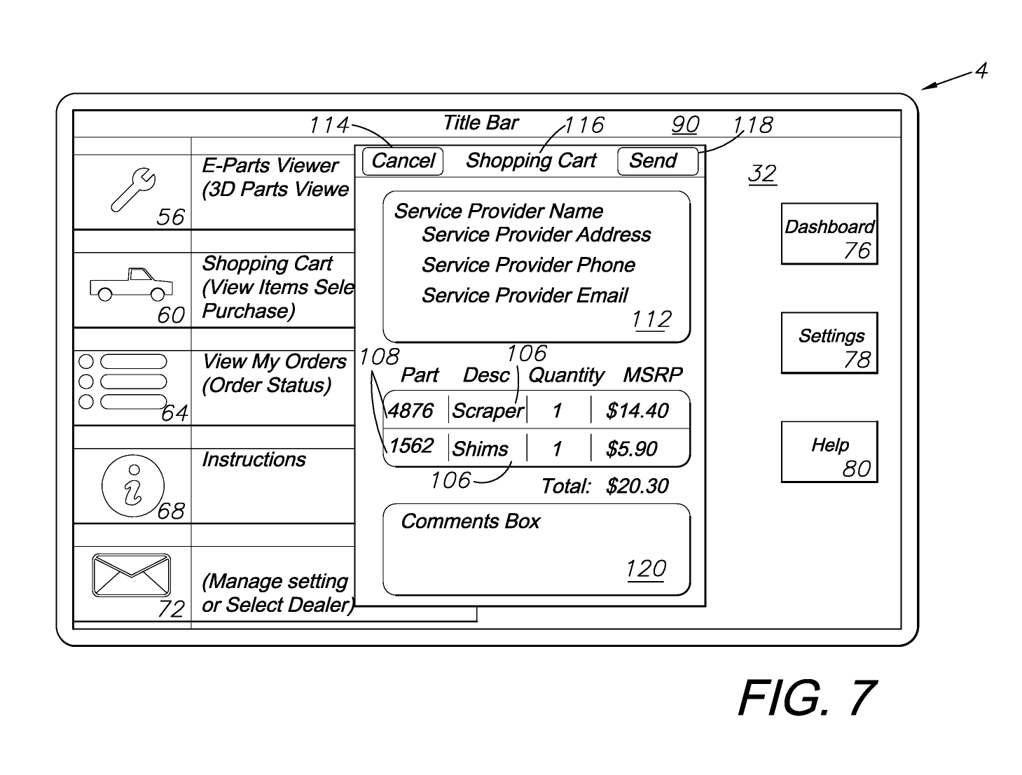

Finally, FIG. 7 shows an example screen shot of a user interface 32 contained within a personal computing device 4 with one embodiment of a “shopping cart” sub-display screen 116 for the service tool. Once a part is selected, it can be ordered directly from the service tool and placed into a “shopping cart”, a holding area for products acting as a holding location for the parts until the order is submitted or cancelled. This screen shows pricing information, parts lists 106, part numbers 108, shipping information, and other information as appropriate. A chosen service provider 112 is also displayed, which is where the parts may be shipped from. The order for the listed parts can be placed by pressing the “send” button 118. Payment information or the user may be stored within the memory of the personal computing device 4. Comments may be added to the order, such as special delivery requests, and may be inserted in a comment box 120.

Having described the preferred embodiment, it will become apparent that various modifications can be made without departing from the scope of the invention as defined in this document. For example, it may be appropriate to combine the IMT and SMT components into a single application, or to break the functions contained within each component into a larger number of smaller, more specific components. The service tool application could be displayed on a hardwired, dedicated display in a vehicle or on a system, instead of on a mobile device. This might be appropriate for a non-mobile industrial application, such as a mounting a display directly on a printing press to allow the service tool to be used when the press has a service problem. This and other applications and uses of the service tool described herein may be created without deviating from the inventive concept of the present invention.

It is to be understood that while certain aspects of the disclosed subject matter have been shown and described, the disclosed subject matter is not limited thereto and encompasses various other embodiments and aspects.

Having thus described the invention, what is claimed as new and desired to be secured by Letters Patent is:

1. A system for procuring components of an apparatus, which system comprises:
a digital modeler for creating a digital model of the apparatus;
a component source including an inventory of components for the apparatus;
a source computer subsystem configured for storing said digital model and apparatus component information; and
a mobile device configured for: accessing the source computer subsystem; displaying said apparatus and a component of said apparatus; entering an order for said component of said apparatus; and communicating said order to said source computer subsystem.

2. The system according to claim 2, which includes:
said mobile device including an application for varying a display of said apparatus.

3. The system according to claim 3, which includes:
said mobile device display application being adapted for viewing said apparatus from multiple viewpoints.

4. The system according to claim 4, which includes:
said mobile device display application including a view cube configured for a user to select an apparatus view from among multiple viewpoints.

5. The system according to claim 5, which includes:
said apparatus including components selectively visible from different viewpoints.

6. The system according to claim 1, which includes:
said mobile device display application being configured for selecting a display from among multiple possible displays with different viewpoints.

7. The system according to claim 1, which includes:
a service management tool configured for communicating service information via said source computer subsystem to said mobile device.

8. The system according to claim 7, which includes:
said service management tool communicating with said mobile device via the cloud.

9. The system according to claim 1, which includes:
an information management tool having a workflow including model creation, hierarchy assignment, model conversion, complexity limitation and component number.

10. The system according to claim 1, which includes said mobile device being configured for displaying: an apparatus image; component images; a shopping cart including components purchased; order status; shipping instructions; and dealer selection.

11. The system according to claim 1, which includes:
a hierarchy grouped by assemblies, subassemblies and individual components.

12. A computer-implemented method of servicing an apparatus, which method includes the steps of:
creating a digital model of the apparatus;
storing said digital model on a service source computer;
wirelessly connecting a mobile device to said service source computer;
displaying on said mobile device an image of said apparatus;
viewing on said mobile device a service portion of said apparatus; and
ordering service for said apparatus via said mobile device and said service source computer.

13. The method of claim 12, which includes the additional steps of:
creating a database of service information, the service information comprising data related to one or more service providers capable of supplying parts corresponding to the three-dimensional models of components;
uploading the three-dimensional model and database of service information to a centralized server;
providing a mobile device capable of communicating with the centralized server;
transferring the three-dimensional model and subsets of information from the database of service information to the mobile device;
displaying the three-dimensional model and the component models as selected by a user on the mobile device;
allowing the user to select one or more of the service providers; and
allowing the user to order a part directly from the mobile device by interacting with the three-dimensional model and service information.

14. The method of claim 12, which includes the additional steps of:
programming said service source computer with a maintenance schedule for said apparatus, including a component replacement cycle; and
initiating a maintenance procedure via said service source computer based on said maintenance schedule.

15. The method of claim 12, which includes the additional steps of:
programming said service source computer with a maintenance schedule for said apparatus, including a component replacement cycle; and
initiating a maintenance procedure via said service source computer based on said maintenance schedule.

16. The method according to claim 12, which includes a service management tool (SMT) workflow including the steps of:
defining a service area;
specifying contact information;
configuring said ordering process;
linking to component sources;
testing for verifying said component and model in a staging location defined by said service source computer;
publishing said testing results via an output to said mobile device; and
linking to multiple vendors via said service source computer.

17. The method according to claim 16, which includes the additional steps of:
programming said service source computer with predetermined criteria for selecting a parts vendor for a respective component;
selecting a vendor for said component based on said predetermined criteria; and
ordering said component from said vendor based on said predetermined criteria.

18. The method according to claim 17 wherein said predetermined criteria include one or more of: cost, geographic location, availability and delivery time.

19. The method according to claim 12, which includes the additional steps of:
providing an image of said apparatus and multiple components thereof based on a digital, three-dimensional model of said apparatus and its components; and
displaying said image to a service provider via said mobile device.

20. A computer-implemented method of servicing an apparatus, which method includes the steps of:
providing an information management tool (IMT) on a service source computer;
creating digital models of the apparatus and a component of the apparatus;
creating said apparatus and component models with input from a computer-aided drafting and design (CADD) program;
storing said digital model on said service source computer;
wirelessly connecting a mobile device to said service source computer;
displaying on said mobile device an image of said apparatus;
viewing on said mobile device a service portion of said apparatus;
providing a service management tool (SMT) on said service source computer;
ordering service for said apparatus via said mobile device and said service source computer;
programming said service source computer with a maintenance schedule for said apparatus, including a component replacement cycle;
initiating a maintenance procedure via said service source computer based on said component replacement cycle;
linking to multiple vendors via said service source computer;
creating a database of service information, the service information comprising data related to one or more service providers capable of supplying parts corresponding to the three-dimensional models of components;
uploading the three-dimensional model and database of service information to a centralized server;
providing a mobile device capable of communicating with the centralized server;
transferring the three-dimensional model and subsets of information from the database of service information to the mobile device;
displaying the three-dimensional model and the component models as selected by a user on the mobile device;
allowing the user to select one or more of the service providers; and
allowing the user to order a part directly from the mobile device by interacting with the three-dimensional model and service information.
